(19) United States
(12) Patent Application Publication
(10) Pub. No.: US 2012/0263132 A1
(43) Pub. Date: Oct. 18, 2012

(54) METHOD FOR ENCODING RESOURCE INDEXES IN WIRELESS COMMUNICATION SYSTEM, AND BASE STATION

(76) Inventors: Yangfeng Guan, Shenzhen (CN); Xiangyu Liu, Shenzhen (CN); Huiying Fang, Shenzhen (CN); Ying Liu, Shenzhen (CN)

(21) Appl. No.: 13/518,911

(22) PCT Filed: Nov. 11, 2010
(86) PCT No.: PCT/CN2010/078654

§ 371 Date: Jun. 25, 2012

(30) Foreign Application Priority Data
Dec. 28, 2009 (CN) 200910216897.0

(51) Int. Cl. H04W 72/04

(52) U.S. Cl. 370/329

(57) ABSTRACT

A method for encoding resource indexes in a wireless communication system, and a base station are provided in the present invention. The method comprises: a base station dividing L logical resource units into M resource allocation units, wherein M<=L, L<=N, and N is the number of physical resource units; and the base station transmitting indication information to a terminal, wherein the indication information indicates the resource allocation units that the base station assigns to the terminal from the M resource allocation units. The present invention achieves more flexible scheduling and allocation.

### FIELD OF THE INVENTION

The present invention relates to the communication field, and in particular to a method for encoding resource indexes in a wireless communication system, and a base station.

### BACKGROUND OF THE INVENTION

In a wireless communication system in which a base station is used for scheduling control, the scheduling and allocation of all the available resources of the system are conducted by the base station, for example, the base station schedules and allocates the resources for downlink transmission, the resources used by a terminal for uplink transmission and etc. During the transmission process, it is necessary to transmit a resource allocation message in the downlink. The downlink resources of the system will be wasted, and thereby the transmission efficiency of the whole system will be reduced, if no reasonable method for encoding resource index and method for generating resource allocation message are employed.

In different communication systems, the base station may perform resource indication with different methods, different messages or signaling, for example, in the 802.16d/e downlink of Institute for Electrical and Electronic Engineers (referred to as IEEE), in the case of a two-dimensional time domain-frequency domain resource block, the base station provides plural pieces of information in resource allocation control information, such as the starting point of the time domain symbol, the length of time domain symbol, the starting point of frequency domain channel, and the offset of frequency domain channel, and so on, for the resources allocated to each user. And based on such information, the user can uniquely determine the size and location of the resource allocated to the user itself.

In the IEEE 802.16m system, the resource mapping process is relatively complicated, which mainly results from the support to multiple transmission modes for the purpose of constructing a variety of logical resource units. FIG. 1 is a schematic diagram of the resource mapping process of a 5 MHz bandwidth system according to the relevant technology. The downlink resource mapping process generally includes: Subband Partitioning, Miniband Permutation, Frequency Partitioning, Contiguous Resource Unit/Distributed Resource Unit Allocation (referred to as CRU/DRU Allocation) and Subcarrier Permutation. The uplink resource mapping process includes: Subband Partitioning, Miniband Permutation, Frequency Partitioning, Contiguous Resource Unit/Distributed Resource Unit Allocation and Tile Permutation. In the communication system, all the resource mapping indication information is transmitted from the base station to the terminal through a broadcast channel or a super frame header, and the terminal obtains the type and number of the logical resource units based on the resource mapping indication information. The resource mapping indication information indicates the partitioning and mapping of the frequency resources, and can specifically include the following information: the number of allocated downlink subbands, the number of allocated uplink subbands, downlink frequency partition configuration, uplink frequency partition configuration, the number of allocated subbands of downlink frequency partition, the number of allocated subbands of uplink frequency partition, the number of allocated downlink contiguous resource units, the number of allocated uplink contiguous resource units, the number of downlink Miniband-based contiguous resource units, and the number of uplink Miniband-based contiguous resource units. As shown in FIG. 1, there are totally 512 subcarriers on the entire bandwidth, wherein the numbers of protection subcarriers on high frequency bands and low frequency bands are 39 and 40 respectively. These subcarriers do not constitute resource units. Among the 433 subcarriers in the middle, there is one DC subcarrier (or referred to as zero-frequency carrier), and the rest 432 subcarriers constitute N_{PRU} (for example, 24) Physical Resource Units (referred to as PRU) in the unit of Nsym (for example, 18) carriers. Each physical resource unit occupies some OFDM symbols in time domain. These physical resource units are subjected to the process of Subband Partitioning, and are divided into Subband and/or Miniband. In FIG. 1, one subband can consist of N1 (for example, 4) PRUs which constituting the subband are called PRU_{SB}, and one miniband consists of N2 (for example, 1) PRUs, then all of the minibands PRU (referred to as PRU_{MB}) are subjected to miniband permutation to form the permuted minibands PRU (PPRU_{MB}), and then, all of the PRU_{SB} and PRU_{MB} are subjected to Frequency partitioning and are divided into one or more frequency partitions. In FIG. 1, there is only one frequency partition, called FP0, wherein the PRU is called PPRU_{FP0}, then some PPRU_{MB} are selected from each frequency partition for subcarrier mapping, wherein these PRUs which have been subjected to subcarrier mapping are called Distributed Logical Resource Units (referred to as DLRU), and those without being subjected to the subcarrier permutation are called Contiguous logical resource units (referred to as CLRU).

At present, for the resource allocation indication, the method of resource allocation indication based on trinary tree, binary tree, combo tree or Bitmap (also known as bit mapping) is usually employed. Although having a small overhead, the above method cannot effectively indicate the allocation of all the resources, namely, some allocations cannot be indicated, which thereby limits the flexibility of scheduling.

### SUMMARY OF THE INVENTION

The present invention provides a method for encoding resource indexes in a wireless communication system to solve at least the above problems.

According to one aspect of the present invention, a method for encoding resource indexes in a wireless communication system is provided, which comprises: a base station dividing L logical resource units into M resource allocation units, wherein M<=L, L<=N, and N is the total number of physical resource units; and the base station transmitting indication information to a terminal, wherein the indication information indicates the resource allocation units that the base station assigns to the terminal from the M resource allocation units.

Preferably, the L logical resource units, under at least one of multiple system bandwidths supported by the wireless communication system, are divided into M resource allocation units, and the M resource allocation units are divided into K groups.

Preferably, the numbers of logical resource units included in the M resource allocation units respectively are M₁, M₂ . . . , M_{M}, wherein there exist at least one pair of i≠j, in which Mᵢ≠Mⱼ.

$$Wherein , {\sum }_{i = 1}^{M} {M}_{i} = L , 0 ≦ {M}_{i} ≦ L .$$

Preferably, the M resource allocation units are divided into K groups, wherein the total number of resource allocation units in one group is z, in which 1<=K<=M, 1<=z<=M.

Preferably, in the case where K=1, all or part of the bits in the indication information are used to indicate the resource allocation units assigned to the terminal.

Preferably, in the case where 2<=K<=M, some of the bits in the indication information are used to indicate the group in which the resource allocation units assigned to the terminal are located and/or indicate type, and all or part of the rest bits in the indication information are used to indicate the resource allocation units assigned to the terminal in the group.

Preferably, all or part of the bits in the indication information indicate, in the manner of Bitmap, the resource allocation units assigned to the terminal, and one bit in the Bitmap indicates one resource allocation unit or one logical resource unit.

Preferably, in the case where 2<=K<=M, the step of the base station dividing the M resource allocation units into K groups comprises: in the K groups, at least two groups are crossed with each other, wherein two groups crossed with each other means that there is at least one same resource allocation unit or logical resource unit in the two groups therebetween; or in the K groups, any two groups are crossed with each other, wherein any groups are not crossed with each other means that there is no same resource allocation unit or logical resource unit in any two groups therebetween.

Preferably, the L logical resource units are all subband-based logical resource units, wherein one subband includes one or more continuous resource units.

Preferably, L is determined according to the resource mapping indication information.

Preferably, the indication information is binary bits with fixed lengths, or the number of bits of the indication information is determined according to the system bandwidth.

Preferably, the indication information indicates the position and/or the number of the resource allocation units that the base station assigns to the terminal from the M resource allocation units, wherein the position includes an initial position and/or a termination position.

Preferably, the base station indicates, through the indication information, the position and/or the number of the resource allocation units assigned to the terminal, and the terminal obtains, according to the resource allocation units assigned, the position and/or the number of the logical resource units assigned.

According to one aspect of the present invention, a method for encoding resource indexes in the wireless communication system is provided, which comprises: a base station dividing L logical resource units into K groups, wherein 1<K<=L, L<=N, and N is the total number of physical resource units; and the base station transmitting indication information to the terminal, wherein all or part of the bits of the indication information indicate logical resource units that the base station assigns to the terminal from the L logical resource units in the K groups.

Preferably, some of the bits in the indication infolination are used to indicate the group or groups in which the logical resource units assigned to the terminal are located, and all or part of the rest bits in the indication information are used to indicate the logical resource units assigned to the terminal in the group or groups.

Preferably, there exist, in all or part of the rest bits in the indication information apart from said some bits, at least two bits, Bit i and Bit j, in which Nᵢ≠Nⱼ, wherein the numbers of the logical resource units indicated by Bit i and Bit j respectively are Nᵢ and Nⱼ.

Preferably, all or part of the bits in the indication information indicate, in the manner of Bitmap, the logical resource units assigned to the terminal, and one bit in the Bitmap indicates one or more logical resource units.

Preferably, the step of the base station dividing the L resource allocation units into K groups comprises: in the K groups, at least two groups are crossed with each other, wherein two groups are crossed with each other means that there is at least one same physical resource unit or logical resource unit in the two groups therebetween; or in the K groups, any two groups are not crossed with each other, wherein any two groups are not crossed with each other means that there is no same physical resource unit or logical resource unit in any two groups therebetween.

Preferably, the L logical resource units are all subband-based logical resource units, wherein one subband includes one or more continuous resource units.

Preferably, L is determined according to the resource mapping indication information.

Preferably, the indication information is binary bits with fixed lengths, or the number of bits of the indication information is determined according to the system bandwidth.

Preferably, the indication information indicates the position and/or the number of the logical resource units that the base station assigns to the terminal from the L logical resource units, and the position includes an initial position and/or a termination position.

According to another aspect of the present invention, a base station is provided, comprising: a first assigning module configured for dividing L logical resource units into M resource allocation units, wherein M<=L, L<=N, and N is the number of physical resource units; and a transmitting module configured for transmitting indication information to a terminal, wherein the indication information is used to indicate resource allocation units that the base station assigns to the terminal from M resource allocation units.

With the present invention, by dividing the logical resource units into resource allocation units, then further dividing the resource allocation units into groups, and transmitting indication information to the terminal, the problem existing in the relevant technology that the manner of the resource allocation indication restricts the flexibility of scheduling is solved, and thereby the effect of more flexible scheduling and allocation is achieved.

### BRIEF DESCRIPTION OF THE DRAWINGS

The drawings illustrated here provide a further understanding of the present invention and form a part of the present application. The exemplary embodiments and the description thereof are used to explain the present invention, without unduly limiting scope of the present invention, wherein:

FIG. 1 is a schematic diagram of the resource mapping process of a 5 MHz bandwidth system according to the relevant technology;

FIG. 2 is a flow chart of the method for encoding resource indexes in the wireless communication system according to an embodiment of the present invention;

FIG. 3 is a structural block diagram of the base station according to an embodiment of the present invention;

FIG. 4 is a preferable structural block diagram of the base station according to an embodiment of the present invention;

FIG. 5 is a schematic diagram of the resource mapping process of a 5 MHz bandwidth system according to a preferred embodiment of the embodiments of the present invention;

FIG. 6 is schematic Diagram 1 of the encoding and indication of the resource unit index of a 5 MHz bandwidth system according to the preferred Embodiment 1 of the embodiments of the present invention;

FIG. 7 is schematic Diagram 2 of the encoding and indication of the resource unit index of a 5 MHz bandwidth system according to the preferred Embodiment 1 of the embodiments of the present invention;

FIG. 8 is schematic Diagram 1 of the encoding and indication of the resource unit index of a 5 MHz bandwidth system according to the preferred Embodiment 2 of the embodiments of the present invention;

FIG. 9 is schematic Diagram 2 of the encoding and indication of the resource unit index of a 5 MHz bandwidth system according to the preferred Embodiment 2 of the embodiments of the present invention;

FIG. 10 is schematic Diagram 1 of the encoding and indication of the resource unit index of a 5 MHz bandwidth system according to the preferred Embodiment 3 of the embodiments of the present invention;

FIG. 11 is schematic Diagram 2 of the encoding and indication of the resource unit index of a 5 MHz bandwidth system according to the preferred Embodiment 3 of the embodiments of the present invention;

FIG. 12 is a schematic diagram of the encoding and indication of the resource unit index when L=28 according to the preferred Embodiment 3 of the embodiments of the present invention;

FIG. 13 is a schematic diagram of the encoding and indication of the resource unit index of a 5 MHz bandwidth system according to the preferred Embodiment 4 of the embodiments of the present invention;

FIG. 14 is schematic Diagram 1 of the encoding and indication of the resource unit index when L=16 according to the preferred Embodiment 4 of the embodiments of the present invention; and

FIG. 15 is schematic Diagram 2 of the encoding and indication of the resource unit index when L=16 according to the preferred Embodiment 4 of the embodiments of the present invention.

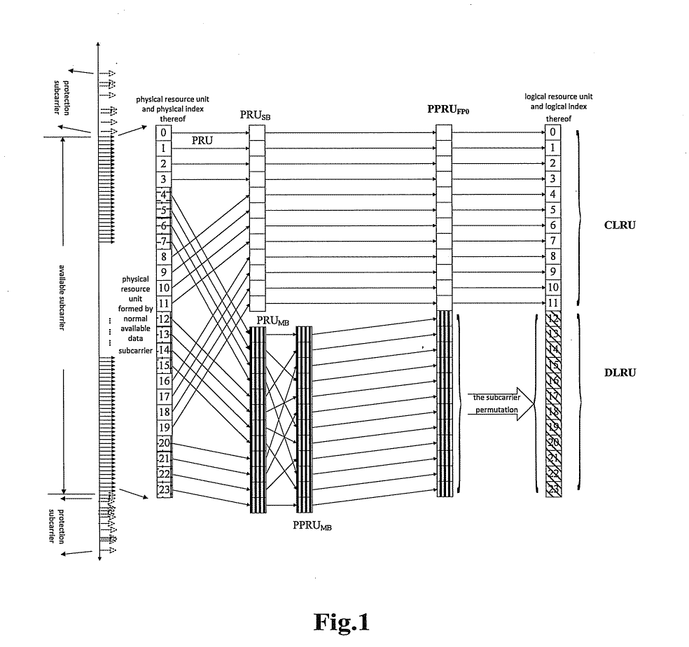

### DETAILED DESCRIPTION OF EMBODIMENTS

The present invention is described in detail as follows with reference to the drawings and in conjunction with the embodiments. It shall be explained that the embodiments of the present application and the features of the embodiments can be combined with each other if there is no conflict.

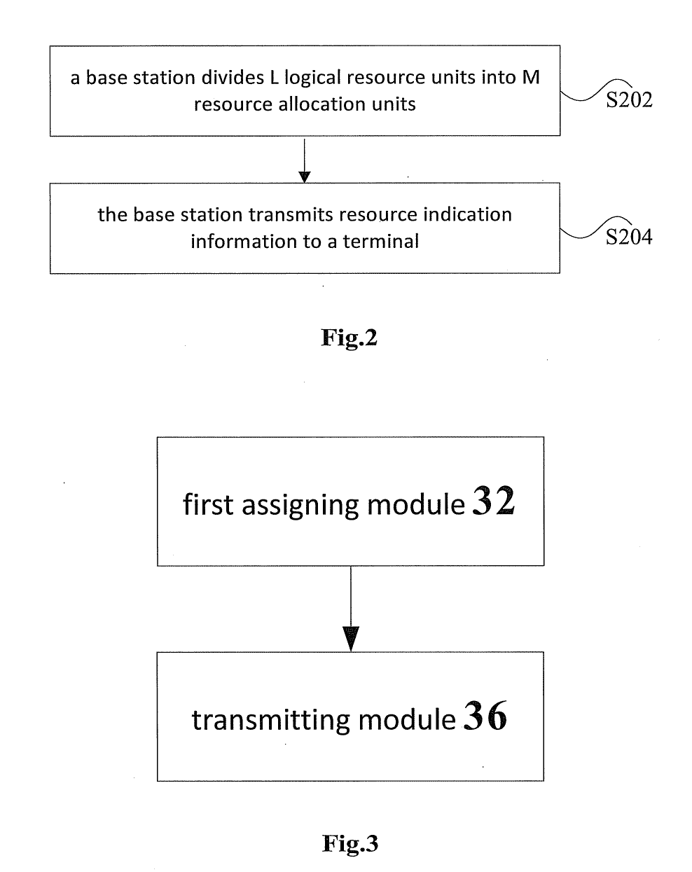

The resources in the following embodiments refer to uplink resources or downlink resources. In the present embodiment, a method for encoding resource indexes in the wireless communication system is provided. FIG. 2 is a flow chart of the method for encoding resource indexes in the wireless communication system according to an embodiment of the present invention. As shown in FIG. 2, the method comprises the steps:

step S202, a base station divides L logical resource units into M resource allocation units, wherein M<=L, and for instance, the L logical resource units can be divided into M resource allocation units [M₁, M₂, . . . , M_{M}], wherein when M<L, among the M resource allocation units, at least two resource allocation units include the logical resource units different in number, that is, there exist at least one pair of i and j, wherein when i≠j, Mᵢ≠Mⱼ; and

step S204, the base station transmits resource indication information (referred to as indication information) to a terminal, wherein the indication information is used to indicate the resource allocation units that the base station selects from the M resource allocation units to assign to the terminal, wherein the indication information can indicate the number and/or the position of the resources assigned by the base station. Preferably, the position can include an initial position or a termination position, or include both the initial position and the termination position.

Through step S202 to step S204, the indication is performed with the resource allocation unit being used as a unit, the number of logical resources included in the resource allocation units can be set flexibly, which thereby realizes that flexible encoding and indication manners are employed in accordance with different bandwidths, different numbers of resources, and different resource allocation granularities, and settles the problem that the scheduling is not flexible enough in the relevant technology.

Preferably, for L logical resource units, wherein 0≦L≦N, N is the total number of logical resource units, there exists at least one method for encoding resource indexes of L, which satisfies the method in step S202 to step S204, wherein that there exists at least one method for encoding resource indexes of L which satisfies the method refers to: at least one of the multiple system bandwidths supported by the wireless communication system has one L value satisfying the method, which is similar to other situations, and here, no further description is made in this regard.

Preferably, in the case of different L values at the same system bandwidth, 0≦L≦N, N is the total number of physical resource units, and L is determined according to the resource mapping indication information.

Preferably, for achieving more flexible processing, the M resource allocation units can also be divided into K groups, wherein the total number of resource allocation units in one group is z, 1<=K<=M, 1<=z<=M. For instance, the M resource allocation units can be divided into K groups, S₁, S₂, . . . , S_{K}, each group has K₁, K₂, . . . , K_{K} resource allocation units, 1≦K≦M.

Similarly, considering that the resource allocation unit is an intermediate sector which can be omitted, L logical resource units are directly divided into K groups, and the number of logical resource units in each group is Lᵢ which is indicated by a binary bit. Each binary bit indicates one or more logical resource units. It shall be noted that, it is only required that there exists at least one L value which satisfies the method in which resource allocation units are omitted and logical resource units are directly divided into groups.

In the case where the resource allocation units are omitted, some of the bits in the indication information are used to indicate the group in which the logical resource units assigned to the terminal are located, and all or part of the rest bits in the indication information are used to indicate the logical resource units assigned to the terminal in the group. Preferably, in the indication information, there exist, in all or part of the bits with the exception of the bits indicating the group in which the logical resource units assigned to the terminal are located, at least two bits, Bit i and Bit j, so that the numbers of the logical resource units, indicated by Bit i and Bit j, respectively are Ni and Nj, wherein Ni is not equal to Nj. Preferably, all or part of the bits in the indication information indicate, in the manner of Bitmap, the logical resource units assigned to the terminal, wherein one bit in the Bitmap indicates one or more logical resource units.

Preferably, in the case where K=1, the indication information is used to indicate the resource allocation units assigned to the terminal in the manner of Bitmap, that is, the number and/or the position of the resources can be indicated through all or part of the bits of the indication information in the manner of Bitmap. In the case where 2<=K<=M, some of the bits in the indication information are used to indicate the group in which the resource allocation units assigned to the terminal are located, and/or indicate the type, and all or part of the rest bits in the indication information are used to indicate the resource allocation units assigned to the terminal in the groups assigned to the terminal. That is, some bits among all the bits in the indication information indicate the group in which the assigned resources are located, and the remaining bits indicate the number and/or the position of the resources. Preferably, all or part of the bits in the indication information indicate, in the manner of Bitmap, the resource allocation units assigned to the terminal, and one bit in the Bitmap can indicate one resource allocation unit or one logical resource unit.

Preferably, when 2<=K<=M, there are at least two groups crossed with each other, two groups are crossed with each other means that there is at least one same resource allocation unit therebetween, for instance, i≠j, wherein 1≦i<j≦K, Sᵢ and Sⱼ have at least one same resource allocation unit or logical resource unit in the two groups therebetween. Or any two groups are not crossed with each other, wherein that any two groups are not crossed with each other means that there is no same resource allocation unit or logical resource unit in the two groups therebetween, for instance, for any i≠j, 1≦i<j≦K, Sᵢ and Sⱼ have no same resource allocation unit or logical resource unit.

Corresponding to the above description, a base station is provided in the embodiment. FIG. 3 is a structural block diagram of the base station according to an embodiment of the present invention, wherein the base station is used to implement the above embodiments, the description that has been made in the above contents will not be repeated herein, and the modules of the base station are now described as follows. As shown in FIG. 3, the base station comprises: a first assigning module 32 and a transmitting module 36. The two modules are respectively described as follows.

The first assigning module 32 is used for dividing L logical resource units into M resource allocation units, wherein M<=L; and the transmitting module 36 is connected to the first assigning module 32 for transmitting indication information to a terminal, wherein the indication information is used to indicate resource allocation units that the base station assigns to the terminal from the M resource allocation units.

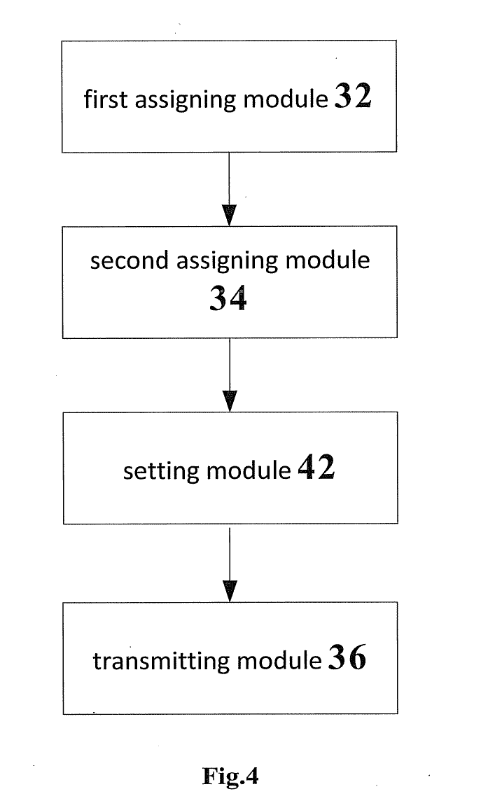

FIG. 4 is a preferable structural block diagram of the base station according to an embodiment of the present invention. As shown in FIG. 4, the base station further comprises: a second assigning module 34 connected to the first assigning module 32 for dividing M resource allocation units into K groups, wherein 1<=K<=M; and a setting module 42 connected to the second assigning module 34 and the transmitting module 36, for setting, in the case where K=1, the indication information to indicate, in the manner of Bitmap, the resource allocation units assigned to the terminal.

Preferably, the setting module 42 is also used for setting, in the case where 2<=K<=M, predetermined bits of the indication information to indicate the group in which the resource allocation units assigned to the terminal are located, and setting all or part of the bits in the indication information, with the exception of the predetermined bits, to indicate the resource allocation units assigned to the terminal in the groups assigned to the terminal.

Preferably, the second assigning module 34 is used for dividing, in the case where 2<=K<=M, M resource allocation units into K groups which have at least two groups crossed, wherein two groups crossed with each other means that there is at least one same resource allocation unit or logical resource unit in the two groups. Alternatively, the second assigning module 34 is used for dividing, in the case where 2<=K<=M, the M resource allocation units into K groups which have not any two groups crossed, wherein having not any two groups crossed with each other means that there is no same resource allocation unit or logical resource unit in any two groups.

Preferably, the L logical resource units can be subband-based logical resource units, wherein one subband can include one or more continuous resource units.

Preferably, the above indication information can be fixed binary bits, (for example, 11 bits, description of which is made in the following preferred embodiments with 11 bits as the example), or the number of bits contained in the indication information can be determined according to the system bandwidth, for example, a 10 MHz system uses N bits, a 20 MHz system uses N+1 bits, and a 5 MHz system uses N−1 bits.

The preferred embodiments will be described in conjunction with the drawings thereof.

### Preferred Embodiment 1

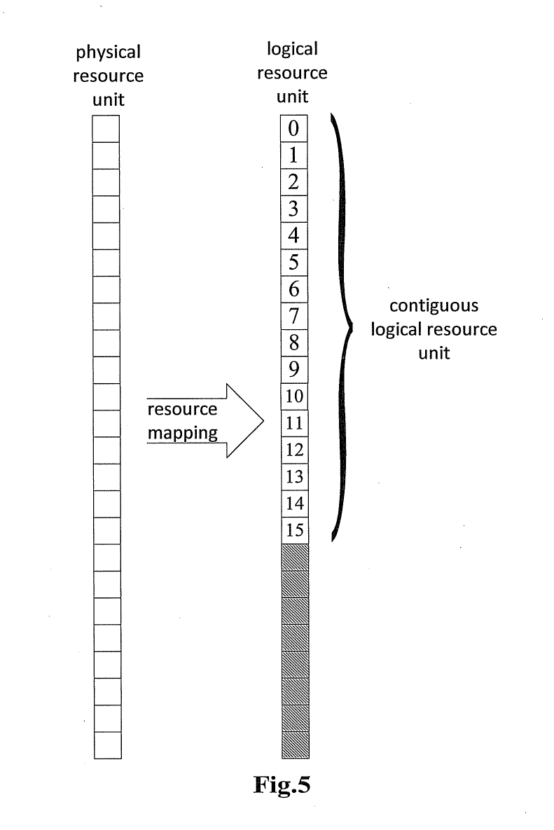

In the present embodiment, the available physical subcarriers of a 5 MHz system (the system uses 512 point FFT) are subjected to resource mapping. FIG. 5 is a schematic diagram of the resource mapping process of a 5 MHz bandwidth system according to a preferred embodiment of the embodiments of the present invention. As shown in FIG. 5, L (L=24) logical resource units are obtained. Among the 24 logical resource units, there is one frequency partition, namely FP₀. If FP₀ includes 4 subbands, namely 16 Contiguous Logic Resource Units (referred to as CLRU), wherein one subband comprises four logic resource units with totally contiguous subcarriers, as these CLRUs are based on subband, they can be called Subband-based LRUs (referred to as SLRU).

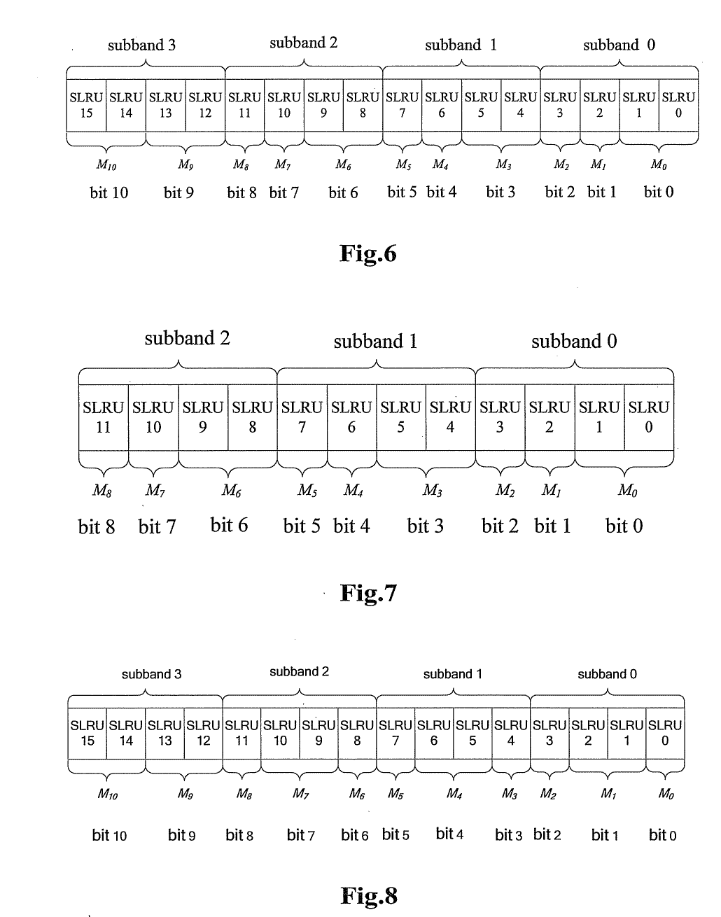

FIG. 6 is schematic Diagram 1 of encoding and indication of the resource unit index of a 5 MHz bandwidth system according to the preferred Embodiment 1 of the embodiments of the present invention. As shown in FIG. 6, the number of the bits indicating resource indexes is 11, with 11 bits as the example for description herein, but the present invention is not limited to 11 bits.

The 16 contiguous logical resource units whose indexes are [SLRU₀, SLRU₁, SLRU₂, SLRU₃, SLRU₄, SLRU₅, SLRU₆, SLRU₇, SLRU_{g}, SLRU₉, SLRU₁₀, SLRU₁₁, SLRU₁₂, SLRU₁₃, SLRU₁₄, SLRU₁₅] in four subbands are divided into M (M=11) resource allocation units, and each allocation unit includes M₁, M₂, . . . , M_{M} contiguous logical resource units, wherein M₀=M₃=M₆=M₉=M₁₀=2, M₁=M₂=M₄=M₅=M₇=M₈=1. M₀ includes [SLRU₀, SLRU₁], M₁ includes [SLRU₂], M₂ includes [SLRU₃], M₃ includes [SLRU₄, SLRU₅], M₄ includes [SLRU₆], M₅ includes [SLRU₇], M₆ includes [SLRU₀, SLRU₉], M7 includes [SLRU₁₀], M8 includes [SLRU₁₁], M9 includes [SLRU₁₂, SLRU₁₃], and M₁₀ includes [SLRU₁₄, SLRU₁₅].

The M resource allocation units are divided into K (K=1) group, then there are K₁ (K₁=11) resource allocation units in the group.

There are totally 11 bits in the resource indication information, the 11 bits indicate the number and the position of the resources in the manner of Bitmap, namely, Bit i is used to indicate the resource allocation unit Mᵢ, Bit i=1 means that the resource allocation unit Mi has been assigned, Bit i=0 means that the resource allocation unit Mi hasn't been assigned. For instance, bit 0 indicates the resource allocation unit M₀, bit 8 indicates the resource allocation unit M₈. If the 11 bits are [010, 0000, 0010], it means that the magnitude of resource assignment is three contiguous logical resource units, and the resource allocation unit M₁ and the resource allocation unit M₉ have been assigned, that is, the contiguous logical resource units [SLRU₂, SLRU₁₂, SLRU₁₃] have been assigned.

In the present embodiment, if the L (L=24) logical resource units are divided into 3 frequency partitions, namely FP₁, FP₂, FP₃, the frequency partitions respectively have 8, 8, 8 LRUs, and FP₁, FP₂ and FP₃ each include one subband, then there are 3 subbands altogether, namely 12 contiguous logical resource units.

FIG. 7 is schematic Diagram 2 of encoding and indication of the resource unit index of a 5 MHz bandwidth system according to the preferred Embodiment 1 of the embodiments of the present invention. As shown in FIG. 7, the number of the bits indicating resource indexes is 11 as well.

The indexes of 12 contiguous logical resource units are [SLRU₀, SLRU₁, SLRU₂, SLRU₃, SLRU₄, SLRU₅, SLRU₆, SLRU₇, SLRU₈, SLRU₉, SLRU₁₀, SLRU₁₁], and the 12 contiguous logical resource units are divided into M (M=9) resource allocation units, each including M₀, M₁, . . . , M₈ contiguous logical resource units, wherein M₀=M₃=M₆=2, M₁=M₂=M₄—M₆=M₇=M₈=1, M₀ includes [SLRU₀, SLRU₁], M₁ includes [SLRU₂], M₂ includes [SLRU₃], M₃ includes [SLRU₄, SLRU₅], M₄ includes [SLRU₆], M₅ includes [SLRU₇], M₆ includes [SLRU₈, SLRU₉], M₇ includes [SLRU₁₀], and M₈ includes [SLRU₁₁].

The M resource allocation units are divided into K (K=1) group, then there are K₁=11 resource allocation units in the group.

There are totally 11 bits in the resource indication information, the 11 bits indicate the number and the position of the resources in the manner of Bitmap, namely Bit i is used to indicate the resource allocation unit Mᵢ, Bit i=1 means that the resource allocation unit Mi has been assigned, Bit i=0 means that the resource allocation unit Mi hasn't been assigned. For instance, bit 0 indicates the resource allocation unit M₀, and bit 8 indicates the resource allocation unit M₈. If the 11 bits are [000, 0001, 0111], it means that the magnitude of resource assignment is four contiguous logical resource units, the resource allocation unit M₀, M₁, M₂ and the resource allocation unit M₄ have been assigned, namely the contiguous logical resource units [SLRU₀, SLRU₁, SLRU₂, SLRU₃, SLRU₆] have been assigned.

It can be seen from the above 12 contiguous logical resource units that there are totally 11 bits in the resource indication information, but only 9 bits are used, and the rest is reserved bits. Here, it is feasible to reduce 2 resource allocation units which include 2 contiguous logical resource units, and add 2 resource allocation units which include 1 contiguous logical resource unit, so as to enhance the flexibility of resource indication which however will make the encoding and indication methods complicated, thus each having its own advantages and disadvantages.

### Preferred Embodiment 2

Different solutions can be derived based on the preferred Embodiment 1. In Embodiment 1, the corresponding relation between [SLRU₀, SLRU₁, SLRU₂, SLRU₃] in Subband 0 and Bit 0, Bit 1, Bit 2 is that Bit 0 corresponds to [SLRU₀, SLRU₁], Bit 1 corresponds to [SLRU₂], Bit 2 corresponds to [SLRU₃], which can be changed as: Bit 0 corresponding to [SLRU₀], Bit 1 corresponding to [SLRU₃, SLRU₂], Bit 2 corresponding to [SLRU₃], or Bit 0 corresponding to [SLRU₀], Bit 1 corresponding to [SLRU₁], Bit 2 corresponding to [SLRU₂, SLRU₃]. And for other Subbands, similar methods can be employed, and no description is made here. For instance, similarly in the case where there are 16 or 12 contiguous logical resource units and the number of bits indicating resource indexes is also 11, the resource index encoding and indication methods can be as follows.

FIG. 8 is schematic Diagram 1 of encoding and indication of the resource unit index of a 5 MHz bandwidth system according to the preferred Embodiment 2 of the embodiments of the present invention. As shown in FIG. 8, for 16 contiguous logical resource units, the indexes are [SLRU₀, SLRU₁, SLRU₂, SLRU₃, SLRU₄, SLRU₅, SLRU₆, SLRU₇, SLRU₈, SLRU₉, SLRU₁₀, SLRU₁₁, SLRU₁₂, SLRU₁₃, SLRU₁₄, SLRU₁₅], and the 16 contiguous logical resource units are divided into M (M=11) resource allocation units, each including M₁, M₂, . . . , M₈ contiguous logical resource units, wherein M₁=M₄=M₇=M₉=M₁₀=2, M₀=M₂=M₃=M₅=M₆=M₈−1, M₀ includes [SLRU₀], M1 includes [SLRU₁, SLRU₂], M₂ includes [SLRU₃], M₃ includes [SLRU₄], M₄ includes [SLRU₅, SLRU₆], M₅ includes [SLRU₇], M₆ includes [SLRU₈], M₇ includes [SLRU₉, SLRU₁₀], M₈ includes [SLRU₁₁], M₉ includes [SLRU₁₂, SLRU₁₃], and M₁₀ includes [SLRU₁₄, SLRU₁₅].

The M resource allocation units are divided into K (K=1) group, then there are K₁=11 resource allocation units in the group.

There are totally 11 bits in the resource indication information, and the 11 bits indicate the number and the position of the resources in the manner of Bitmap, namely Bit i is used to indicate the resource allocation unit Mᵢ, Bit 1=1 means that the resource allocation unit Mi has been assigned, Bit i=0 means that the resource allocation unit Mᵢ hasn't been assigned. For instance, bit 0 indicates the resource allocation unit M₀, bit 8 indicates the resource allocation unit M₈. If the 11 bits are [010, 0000, 0010], it means that the magnitude of resource assignment is four contiguous logical resource units, the resource allocation unit M₁ and the resource allocation unit M₉ have been assigned, that is, the contiguous logical resource units [SLRU₁, SLRU₂, SLRU₁₂, SLRU₁₃] have been assigned.

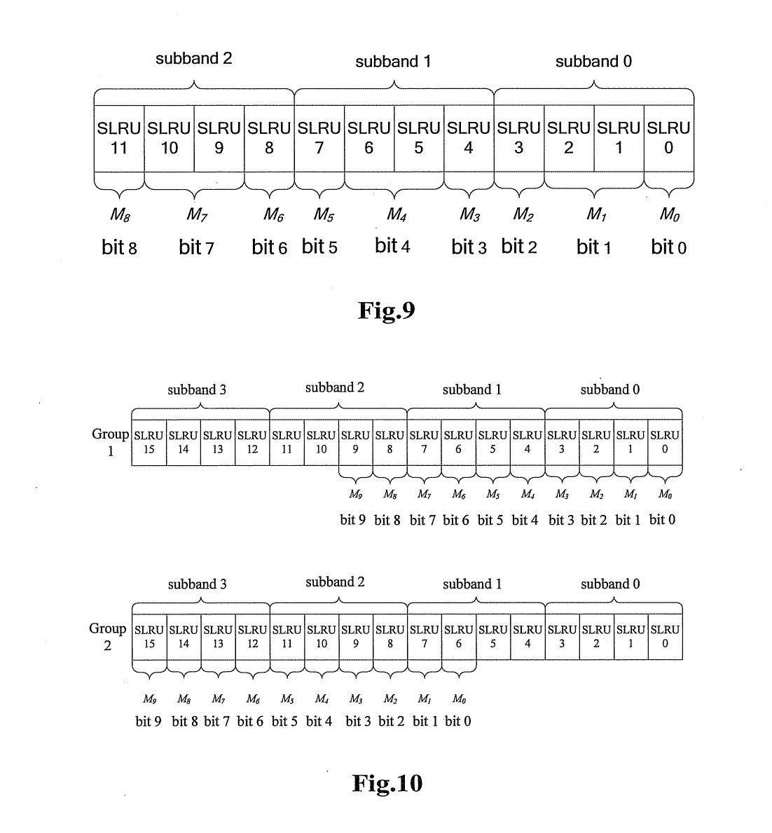

FIG. 9 is schematic Diagram 2 of encoding and indication of the resource unit index of a 5 MHz bandwidth system according to the preferred Embodiment 2 of the embodiments of the present invention. As shown in FIG. 9, for 12 contiguous logical resource units, the indexes are [SLRU₀, SLRU₁, SLRU₂, SLRU₃, SLRU₄, SLRU₅, SLRU₆, SLRU₇, SLRU₈, SLRU₉, SLRU₁₀, SLRU₁₁], and the 12 contiguous logical resource units are divided into M (M=9) resource allocation units, each including M₀, M₁, . . . , M₈ contiguous logical resource units, wherein M₁=M₄=M₇=2, M₀=M₂M₃=M₅=M₆=M₈−1, M₀ includes [SLRU₀], M₁ includes [SLRU₁, SLRU₂], M₂ includes [SLRU₃], M₃ includes [SLRU₄], M₄ includes [SLRU₅, SLRU₆], M₅ includes [SLRU₇], M₆ includes [SLRU₈], M₇ includes [SLRU₉, SLRU₁₀], and M8 includes [SLRU₁₁].

The M resource allocation units are divided into K (K=1) group, then there are K₁=11 resource allocation units in the group.

There are totally 11 bits in the resource indication information, the 11 bits indicate the number and the position of the resources in the manner of Bitmap, namely Bit i is used to indicate the resource allocation unit Mi, Bit i=1 means that the resource allocation unit Mi has been assigned, Bit i=0 means that the resource allocation unit Mi hasn't been assigned. For instance, bit 0 indicates the resource allocation unit M0, and bit 8 indicates the resource allocation unit M8. If the 11 bits are [000, 0001, 0111], it means that the magnitude of resource assignment is five contiguous logical resource units, the resource allocation units M₀, M₁, M₂ and the resource allocation unit M4 have been assigned, that is, the contiguous logical resource units [SLRU₀, SLRU₁, SLRU₂, SLRU₃, SLRU₅, SLRU₆] have been assigned.

### Preferred Embodiment 3

The common feature between the present embodiment and Embodiments 1 and 2 is: for particular L contiguous logical resource units, the resource allocation units which can be assigned are all in one group, namely K=1. The present embodiment prescribes the case where K>2.

Based on the scene of Embodiment 1, for instance, similarly in the case where there are 16 contiguous logical resource units and the number of bits indicating resource indexes is 11, the method of resource encoding and indication is employed in which K>2, and the method of resource index encoding and indication can be as follows.

FIG. 10 is schematic Diagram 1 of encoding and indication of the resource unit index of a 5 MHz bandwidth system according to the preferred Embodiment 3 of the embodiments of the present invention. As shown in FIG. 10, for 16 contiguous logical resource units, the indexes are [SLRU₀, SLRU₁, SLRU₂, SLRU₃, SLRU₄, SLRU_{S}, SLRU₆, SLRU₇, SLRU₈, SLRU₉, SLRU₁₀, SLRU₁₁, SLRU₁₂, SLRU₁₃, SLRU₁₄, SLRU₁₅], and the 16 contiguous logical resource units are divided into M (M=16) resource allocation units, each including M₀, M₁, . . . , M₁₅ contiguous logical resource units, wherein M₀=M₁=M₂=M₃=M₄=M₄=M₅=M₆=M₇=M₈=M₉=M₁₀=M₁₁=M₁₂=M₁₃=M₁₄=M₁₅, Mᵢ includes [SLRUᵢ].

The M resource allocation units are divided into K (K=2) groups, then there are K₁=10 resource allocation units in Group 1, namely [SLRU₀, SLRU₁, SLRU₂, SLRU₃, SLRU₄, SLRU₅, SLRU₆, SLRU₇, SLRU₈, SLRU₉], and there are K₂=10 resource allocation units in Group 2, namely [SLRU₆, SLRU₇, SLRU₈, SLRU₉, SLRU₁₀, SLRU₁₁, SLRU₁₂, SLRU₁₃, SLRU₁₄, SLRU₁₈]. It is obvious that the two groups have same contiguous logical resource units [SLRU₆, SLRU₇, SLRU₈, SLRU₉].

There are totally 11 bits in the resource indication information, the 11 bits indicate the number and the position of the resources in the manner of Bitmap, wherein one of the bits, for instance, Bit 10, is used to distinguish the groups, for instance, Bit 10=0 indicates Group 1, Bit 10=1 indicates Group 2. The remaining bits are used to indicate resource assignment, for instance, Bit i (0≦i≦9) is used to indicate the resource allocation unit Mi, Bit i=1 means that the resource allocation unit Mi has been assigned, Bit i=0 means that the resource allocation unit Mi hasn't been assigned. For instance, bit 0 indicates the resource allocation unit M₀, bit 8 indicates the resource allocation unit M8. If the 11 bits are [010, 0000, 0011], it means that Group 1 is indicated, and the magnitude of resource assignment is three contiguous logical resource units, the resource allocation units M₀, M₁ and the resource allocation unit M₉ have been assigned, that is, the contiguous logical resource units [SLRU₀, SLRU₁, SLRU₉] have been assigned.

In addition, the division of Group 1 and Group 2 can be performed according to the following method.

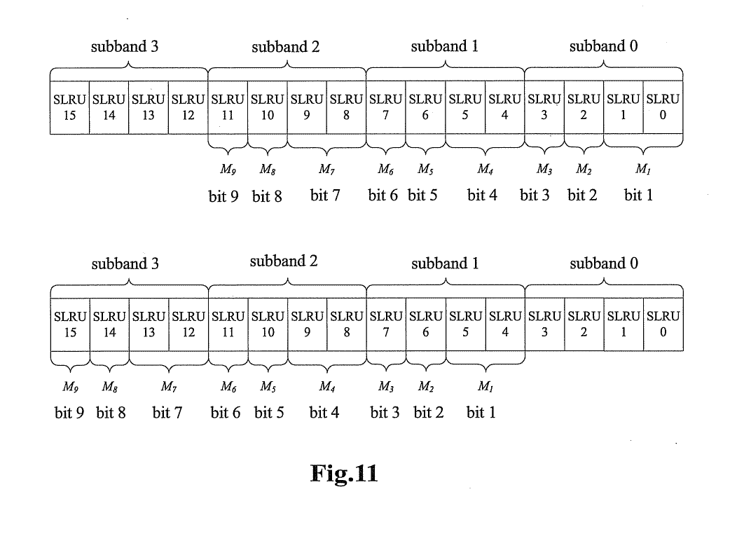

FIG. 11 is schematic Diagram 2 of encoding and indication of the resource unit index of a 5 MHz bandwidth system according to the preferred Embodiment 3 of the embodiments of the present invention. As shown in FIG. 11, for 16 contiguous logical resource units, the indexes are [SLRU₀, SLRU₁, SLRU₂, SLRU₃, SLRU₄, SLRU₅, SLRU₆, SLRU₇, SLRU₈, SLRU₉, SLRU₁₀, SLRU₁₁, SLRU₁₂, SLRU₁₃, SLRU₁₄, SLRU₅], and the 16 contiguous logical resource units are divided into M (M=12) resource allocation units, each including M₁, M₂, . . . , M₁₀ contiguous logical resource units, wherein M₀=M₃=M₆=M₉=2, M₁=M₂=M₄=M₅=M₇=M₈=M₁₁=1, M₀ includes [SLRU₀, SLRU₁], M₁ includes {SLRU₂}, M₂ includes [SLRU₃], M₃ includes [SLRU₄, SLRU₅], M₄ includes [SLRU₆], M₅ includes [SLRU₇], M₆ includes [SLRU₈, SLRU₉], M₇ includes [SLRU₁₀], M₈ includes [SLRU₁₁], M₉ includes [SLRU₁₂, SLRU₁₃], M₁₀ includes [SLRU₁₄], and M₁₁ includes [SLRU₁₅].

The 11 resource allocation units are divided into two groups, there are K₁=10 resource allocation units in Group 1, namely [M₀ M₁ M₂ M₃ M₄ M₅ M₆ M₇ M₈ M₉], that is, [SLRU₀, SLRU₁, SLRU₂, SLRU₃, SLRU₄, SLRU₅, SLRU₆, SLRU₇, SLRU₈, SLRU₉, SLRU₁₀, SLRU₁₁, SLRU₁₂, SLRU₁₃], and there are K₂=10 resource allocation units in Group 2, namely [M₀ M₃ M₄ M₅ M₆ M₇ M₈ M₉ M₁₀ M₁₁] that is, [SLRU₀, SLRU₁, SLRU₄, SLRU₅, SLRU₆, SLRU₇, SLRU₈, SLRU₉, SLRU₁₀, SLRU₁₁, SLRU₁₂, SLRU₁₃, SLRU₁₄, SLRU₁₅].

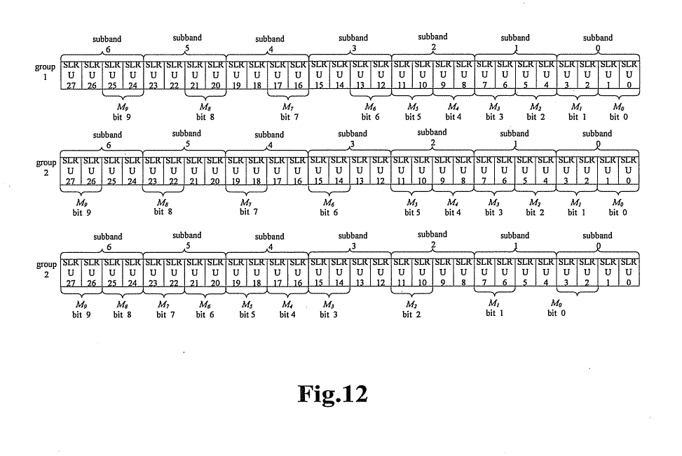

When the number of Subbands is large, for instance, 10 MH or 20 MHz, the number of Subbands is 7, the group dividing method as shown in FIG. 12 can be used, wherein for the Group 2, two methods are provided. The basic principle is similar to that in the above embodiments, and here, no further description is given.

### Preferred Embodiment 4

Different combination solutions can be derived based on Embodiments 1, 2, and 3. For example, similarly in the case where there are 16 contiguous logical resource units and the number of bits indicating resource indexes is 11, the resource index encoding and indication methods can be as follows

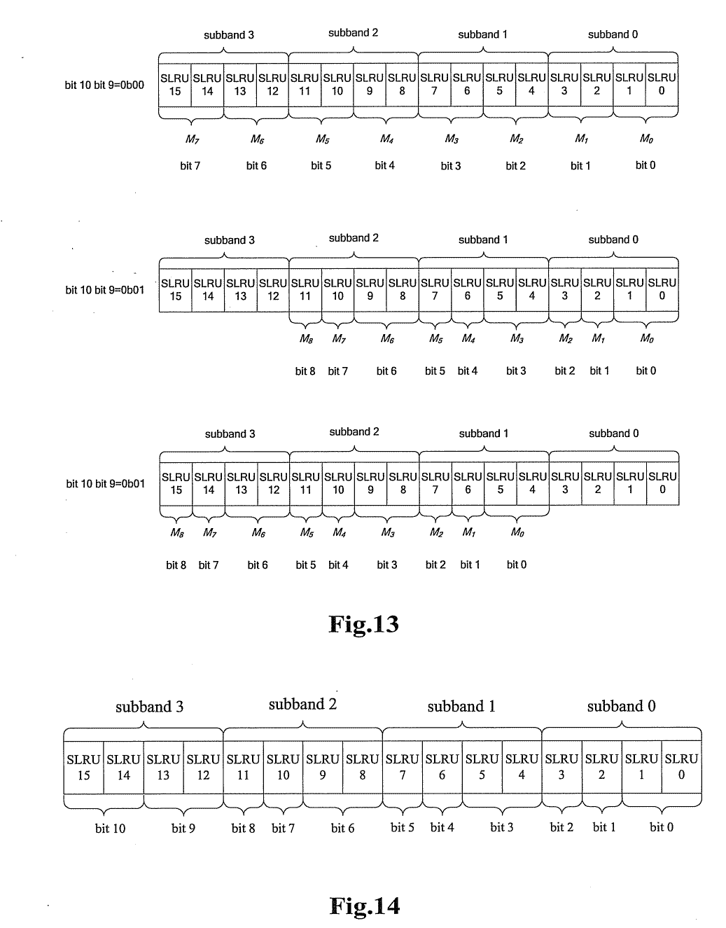

FIG. 13 is a schematic diagram of encoding and indication of the resource unit index of a 5 MHz bandwidth system according to the preferred Embodiment 4 of the embodiments of the present invention. As shown in FIG. 13, two bits in the 11 bit information, for instance, Bit 10 and Bit 9 are used to indicate the resource index encoding mode used.

When Bit 10 Bit 9=0b00, 16 contiguous logical resource units are divided into K (K=1) group, specifically, the 16 contiguous logical resource units [SLRU₀, SLRU), SLRU₂, SLRU₃, SLRU₄, SLRU₅, SLRU₆, SLRU₂, SLRU₈, SLRU₉, SLRU₁₀, SLRU₁₁, SLRU₁₂, SLRU₁₃, SLRU₁₄, SLRU₁₅] are divided into M (M=8) resource allocation units, each including M₀, M₁, . . . , M₇ contiguous logical resource units, wherein M₀=M₁=M₂=M₃=M₄=M₅=M₆=M₇=2, Mᵢ includes [SLRU₂; SLRU₂ᵢ+1]. The low 8 bits of the resource indication information indicate the number and the position of the resources in the manner of Bitmap, that is, Bit i is used to indicate the resource allocation unit M₁, Bit i=1 means that the resource allocation unit M₁ has been assigned, Bit i=0 means that the resource allocation unit Mᵢ hasn't been assigned. For instance, bit 0 indicates the resource allocation unit M₀, and bit 7 indicates the resource allocation unit M₇. If the 11 bits are [000, 0000, 1010], it means that the magnitude of resource assignment is four contiguous logical resource units, the resource allocation unit M₁ and the resource allocation unit M₃ have been assigned, that is, the contiguous logical resource units [SLRU₂, SLRU₃, SLRU₆, SLRU₇] have been assigned.

When Bit 10 Bit 9=0b01 or 0b10, they both mean that 16 contiguous logical resource units are divided into K (K=2) groups, 0b01 indicates assignment of Group 1, and 0b10 indicates assignment of Group 2.

For the 16 contiguous logical resource units, the indexes thereof are [SLRU₀, SLRU₁, SLRU₂, SLRU₃, SLRU₄, SLRU₅, SLRU₆, SLRU₇, SLRU₈, SLRU₉, SLRU₁₀, SLRU₁₁, SLRU₁₂, SLRU₁₃, SLRU₁₄, SLRU₁₅], and the 16 contiguous logical resource units are divided into M (M=12) resource allocation units, each including M₀, M₁, . . . , M₁ contiguous logical resource units, wherein M₀=M₃=M₆=M₉=2, M₁=M₂=M₄=M₅=M₇=M₈=M₁₀=M₁₁=1, M₀ includes [SLRU₀, SLRU₁], M₁ includes [SLRU₂], M₂ includes [SLRU₃], M₃ includes [SLRU₄, SLRU₅], M₄ includes [SLRU₆], M₅ includes [SLRU₇], M₆ includes [SLRU₈, SLRU₉], M₇ includes [SLRU₁₀], M₈ includes [SLRU₁₁], M₉ includes [SLRU₁₂, SLRU₁₃], M₁₀ includes [SLRU₁₄], and M₁₁ includes [SLRU₁₅].

The 12 resource allocation units are divided into two groups, there are K₁=9 resource allocation units in Group 1, namely [M₀ M₁ M₂ M₃ M₄ M₅ M₆ M₇ M₈], that is, [SLRU₀, SLRU₁, SLRU₂, SLRU₃, SLRU₄, SLRU₅, SLRU₆, SLRU₇, SLRU₈, SLRU₉, SLRU₁₀, SLRU₁₁], and there are K₂=9 resource allocation units in Group 2, namely [M₃ M₄ M₅ M₆ M₇ M₈ M₉ M₁₀ M₁₁], that is, [SLRU₄, SLRU₅, SLRU₆, SLRU₇, SLRU₈, SLRU₉, SLRU₁₀, SLRU₁₁, SLRU₁₂, SLRU₁₃, SLRU₁₄, SLRU₁₅].

The above embodiments are all directed to a 5 MHz system. However, they are also applicable to 10 MHz and 20 MHz. For instance, the number of logical resource units in 10 MHz or 20 MHz is 12 or 16, and the methods in Embodiments 1, 2, 3 and 4 also can be employed. Moreover, for other possible L values, the above methods can also be employed.

In all of the above embodiments, the resource allocation units are all indicated by the binary bits, and the logical resource units are determined by the allocation units. In terms of the description of method, the resource allocation unit is an intermediate sector which can be omitted, and the L logical resource units are directly divided into K groups, wherein the number of logical resource units in each group is Lᵢ, which is indicated by the binary bit, each binary bit indicating one or more logical resource units.

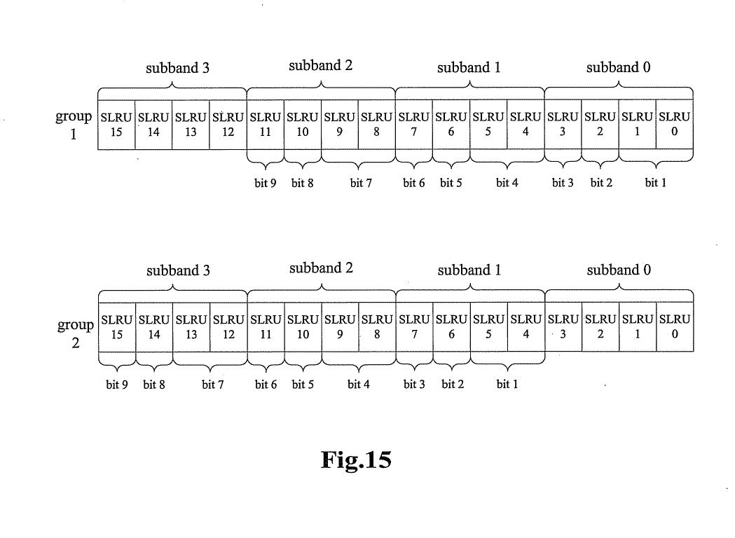

As in FIG. 6 and FIG. 10, after the description of the resource allocation units is omitted, the resource index encoding and indication method is as shown in FIG. 14 and FIG. 15, with the remaining similar to the above Embodiments 1-4, and here, no further description is given.

The method in the above embodiments not only can be shown with forms, but also can be described using graphics, Tree, formulae and combinations thereof. Furthermore, the above embodiments are not limited to a particular system bandwidth, but the methods in the above embodiments can be combined for use according to the system bandwidth size and/or the number of subbands or of logical resource units that need to be indicated. For example, for other systems with irregular bandwidths, by changing subcarrier interval or sampling rate, or through Tone Dropping technique, the systems can be expanded or reduced to systems which are equivalent to a system with standard bandwidth, through such expansion or reduction, the resource bandwidths of the irregular systems can be regarded as belonging to the same kind of bandwidth as a certain standard bandwidth, and here, as to the assignment situation of the system resources, reference can be made to the corresponding standard bandwidth system.

For example, for 8.75 MHz, if the number of FFT points is the same as the number of FFT points of 10 MHz, they are regarded as the same kind of bandwidth, and the same method can be employed for them when they have the same L value.

It shall be explained that the above methods and embodiments can be described by equivalent formulae or forms or illustrations, and they can be regarded as equivalent methods, as long as they can achieve the same effects of indicated logical resource units or resource allocation units, here, we will not go further in this regard.

It shall be explained that, as the resources in the IEEE 802.16m system include subbands and contiguous logical resource units, the method is very applicable to the system, and for other communication systems, it is also applicable.

Owing to the above mentioned, through the above embodiments, it can be realized that flexible encoding and indicating method can be used in accordance with different bandwidths, different numbers of resources, and different resource allocation granularity, so that indication based on Bitmap, overlap grouping-Bitmap or non-overlap grouping-Bitmap can be performed for the resources, which facilitates resource scheduling, and can make full use of the resources. The method saves the overhead of the resource encoding and indication, is beneficial to the improvement of system spectrum efficiency, and achieves a compromise between the flexibility of scheduling and allocation and the overhead of the resource allocation information.

Obviously, those skilled in the art shall understand that the above-mentioned modules or steps of the present invention can be realized by using general purpose calculating device. They can be integrated in one calculating device or distributed on a network which consists of a plurality of calculating devices. Alternatively, the modules and the steps of the present invention can be realized by using the executable program code of the calculating device. Consequently, they can be stored in the storing device and executed by the calculating device, and in some cases, the steps shown or described can be carried out in an order which is different from the order herein, or they are made into integrated circuit module respectively, or a plurality of modules or steps thereof are made into one integrated circuit module. In this way, the present invention is not restricted to any particular hardware and software combination.

The descriptions above are only preferable embodiments of the present invention, which are not used to restrict the present invention. For those skilled in the art, the present invention may have various changes and variations. Any amendments, equivalent substitutions, improvements and etc. within the spirit and principle of the present invention are all included in the scope of the claims of the present invention.

1. A method for encoding resource indexes in a wireless communication system, comprising:
a base station dividing L logical resource units into M resource allocation units, wherein M<=L, L<=N, and N is the total number of physical resource units; and
the base station transmitting indication information to a terminal, wherein the indication information indicates the resource allocation units that the base station assigns to the terminal from the M resource allocation units.

2. The method according to claim 1, wherein the L logical resource units, under at least one of multiple system bandwidths supported by the wireless communication system, are divided into the M resource allocation units.

3. The method according to claim 1, wherein the numbers of logical resource units included in the M resource allocation units respectively are M₁, M₂, . . . , M_{M}, wherein there exist at least one pair of i≠j, in which Mᵢ≠Mⱼ.

4. The method according to claim 1, wherein the M resource allocation units are divided into K groups, wherein the total number of resource allocation units in one group is z, in which 1<=K<=M, 1<=z<=M.

5. The method according to claim 4, wherein in the case where K=1, all or part of the bits in the indication information are used to indicate the resource allocation units assigned to the terminal.

6. The method according to claim 4, wherein in the case where 2<=K<=M, some of the bits in the indication information are used to indicate the group in which the resource allocation units assigned to the terminal are located and/or indicate type, and all or part of the rest bits in the indication information are used to indicate the resource allocation units assigned to the terminal in the group.

7. The method according to claim 5, wherein all or part of the bits in the indication information indicate, in the manner of Bitmap, the resource allocation units assigned to the terminal, and one bit in the Bitmap indicates one resource allocation unit or one logical resource unit.

8. The method according to claim 4, wherein in the case where 2<=K<=M, the step of the base station dividing the M resource allocation units into K groups comprises:
in the K groups, at least two groups are crossed with each other, wherein two groups are crossed with each other means that there is at least one same resource allocation unit or logical resource unit in the two groups therebetween; or
in the K groups, any two groups are not crossed with each other, wherein any two groups are not crossed with each other means that there is no same resource allocation unit or logical resource unit in any two groups therebetween.

9. The method according to claim 1, wherein the L logical resource units are all subband-based logical resource units, wherein one subband includes one or more continuous resource units.

10. The method according to claim 1, wherein L is determined according to the resource mapping indication information.

11. The method according to claim 1 wherein the indication information is binary bits with fixed length, or the number of bits of the indication information is determined according to the system bandwidth.

12. The method according to claim 1, wherein the indication information indicates the position and/or the number of the resource allocation units that the base station assigns to the terminal from the M resource allocation units, wherein the position includes an initial position and/or a termination position.

13. A method for encoding resource indexes in the wireless communication system, comprising:
a base station dividing L logical resource units into K groups, wherein 1<K<=L, L<=N, and N is the total number of physical resource units; and
the base station transmitting indication information to the terminal, wherein all or part of the bits of the indication information indicate logical resource units that the base station assigns to the terminal from the L logical resource units in the K groups.

14. The method according to claim 13, wherein some bits of the bits in the indication information are used to indicate the group or groups in which the logical resource units assigned to the terminal are located, and all or part of the rest bits in the indication information are used to indicate the logical resource units assigned to the terminal in the group or groups.

15. The method according to claim 14, wherein there exist, in all or part of the bits in the indication information apart from said some bits, at least two bits, Bit i and Bit j, in which Nᵢ≠Nⱼ, wherein the numbers of the logical resource units indicated by Bit i and Bit j respectively are Nᵢ and Nⱼ.

16. The method according to claim 13, wherein all or part of the bits in the indication information indicate, in the manner of Bitmap, the logical resource units assigned to the terminal, and one bit in the Bitmap indicates one or more logical resource units.

17. The method according to claim 13, wherein the step of the base station dividing the L resource allocation units into K groups comprises:
in the K groups, at least two groups are crossed with each other, wherein two groups are crossed with each other means that there is at least one same physical resource unit or logical resource unit in the two groups therebetween; or
in the K groups, any two groups are not crossed with each other, wherein any two groups are not crossed with each other means that there is no same physical resource unit or logical resource unit in any two groups therebetween.

18. The method according to claim 13, wherein the L logical resource units are all subband-based logical resource units, wherein one subband includes one or more continuous resource units.

19. The method according to claim 13, wherein L is determined according to the resource mapping indication information.

20. The method according to claim 13, wherein the indication information is binary bits with fixed length, or the number of bits of the indication information is determined according to the system bandwidth.

21. The method according to claim 13, wherein the indication information indicates the position and/or the number of the logical resource units that the base station assigns to the terminal from the L logical resource units, and the position includes an initial position and/or a termination position.

22. A base station, comprising:
a first assigning module configured for dividing L logical resource units into M resource allocation units, wherein M<=L, L<=N, and N is the number of physical resource units; and
a transmitting module configured for transmitting indication information to a terminal, wherein the indication information is used to indicate resource allocation units that the base station assigns to the terminal from the M resource allocation units.

23. The method according to claim 6, wherein all or part of the bits in the indication information indicate, in the manner of Bitmap, the resource allocation units assigned to the terminal, and one bit in the Bitmap indicates one resource allocation unit or one logical resource unit.

24. The method according to claim 2, wherein the L logical resource units are all subband-based logical resource units, wherein one subband includes one or more continuous resource units.

25. The method according to claim 2, wherein L is determined according to the resource mapping indication information.

26. The method according to claim 5, wherein the indication information is binary bits with fixed length, or the number of bits of the indication information is determined according to the system bandwidth.
